(19) United States
(12) Patent Application Publication
(10) Pub. No.: US 2013/0124764 A1
(43) Pub. Date: May 16, 2013

(54) METHOD OF TRANSACTION AND EVENT ORDERING WITHIN THE INTERCONNECT

(71) Applicant: Lantiq Deutschland GmbH, Neubiberg (DE)

(72) Inventors: Gunther Fenzl, Hoehenkirchen-Siegertsbrunn (DE); Thomas Zettler, Hoehenkirchen-Siegertsbrunn (DE); Shi Jiaxiang, Singapore (SG); Stefan Rutkowski, Muenchen (DE)

(73) Assignee: Lantiq Deutschland GmbH, Neubiberg (DE)

(21) Appl. No.: 13/673,230

(22) Filed: Nov. 9, 2012

Related U.S. Application Data
(60) Provisional application No. 61/558,450, filed on Nov. 11, 2011.

(51) Int. Cl. G06F 13/40

(52) U.S. Cl. 710/110

(57) ABSTRACT

The disclosure includes embodiments that apply to an interconnect architecture having multiple system masters and at least one shared resource. The disclosure provides a system and method for providing synchronization for transactions in a multi-master interconnect architecture that employs at least one shared resource, or slave component.

### RELATED APPLICATIONS

This application claims the benefit of U.S. Provisional Application No. 61/558,450, filed Nov. 11, 2011, which is incorporated by reference.

### BACKGROUND

A bus topology, like that shown in FIG. 1 at 100, generally favors one-to-one or one-to-many communications. Such buses architectures may have multiple masters 110 (participants that originate a transaction and source or sink data), but only one master 110 can be active at a time. Inherent in the definition of a bus is its exclusive nature. Only one master 110 can use the bus 112 at a time while all other potential masters 110 must wait. Bus arbitration (i.e., the sharing mechanisms) thus becomes a significant part of any bus specification.

Most buses 112 support multiple masters 110, although, again, only one master 110 can be active at a time. The master 110 competes for access to the bus 112, initiates a transaction, waits for a slave 114 (or in the case of a “broadcall” transaction, multiple slaves) to respond, and then relinquishes the bus 112. The master 110 may then initiate a second transaction or, through arbitration 116, lose control of the bus 112 to another master 110. This arrangement can lead to system bottlenecks where the waiting for access slows the system performance significantly.

### SUMMARY

In one embodiment of the disclosure, a method for performing synchronized transactions in a multi-master interconnect architecture having at least one shared resource is disclosed. The method comprises issuing a write non-posted transaction from a first master component to the interconnect for access to the at least one shared resource, and generating at the first master component an interrupt request for a second master component upon issuance of the write non-posted transaction for indication thereof. The method further comprises receiving a write acknowledgement upon completion of the issued write non-posted transaction, generating an enable signal upon receiving the write acknowledgement, and using the enable signal to pass the generated interrupt request to the second master component, thereby indicating completion of the write non-posted transaction of the first master component and thus avoiding a race condition.

According to another embodiment of the disclosure, a master component configured to operate within a multi-master interconnect architecture that utilizes at least one shared resource is disclosed. The master component comprises an issuance component configured to issue a write non-posted transaction for writing data to the at least one shared resource, and an interrupt request generation component configured to generate an interrupt request upon issuance of the write non-posted transaction. In addition, the master component comprises an enable component configured to pass the generated interrupt request to another master component of the multi-master interconnect architecture upon receipt of a write acknowledgement indicating a completion of the write non-posted transaction.

According to yet another embodiment of the disclosure, a shared resource system configured to operate within a multi-master interconnect architecture is disclosed. The shared resource system comprises a target interface configured to couple to an interconnect for receipt of transactions from a master component via the interconnect, and a shared resource component operably coupled to the target interface and configured to receive data or an instruction via the target interface associated with a received transaction. In addition, the shared resource system comprises a classification logic component operably associated with the target interface and configured to analyze a received transaction passing through the target interface and generate a transaction or an event in response thereto according to pre-defined classification rules.

In still another embodiment of the disclosure, a method of providing synchronization for transactions in a multi-master interconnect architecture having a shared resource is disclosed. The method comprises receiving a transaction at a target interface of the shared resource, wherein the target interface is configured to couple to an interconnect, analyzing the received transaction at the target interface, and generating a transaction or event in response to analyzing the received transaction, wherein the generated transaction or event is local to the shared resource.

### BRIEF DESCRIPTION OF THE DRAWINGS

FIG. 1 is a block diagram of a bus architecture according to the prior art.

FIG. 2 is a block diagram of an interconnect architecture according to the prior art.

FIG. 3 is a block diagram of a multi-master interconnect architecture employing at least one shared resource according to one embodiment of the disclosure.

FIG. 4 is a flow chart diagram illustrating a method of synchronizing transactions in a multi-master interconnect architecture having at least one shared resource according to an embodiment of the disclosure.

FIG. 5 is a flow diagram illustrating a method of providing synchronization for transactions in a multi-master interconnect architecture having a shared resource according to another embodiment of the disclosure.

### DETAILED DESCRIPTION OF THE INVENTION

The disclosure includes embodiments that apply to an interconnect architecture having multiple system masters and at least one shared resource. The disclosure provides a system and method for providing synchronization for transactions in a multi-master interconnect architecture that employs at least one shared resource, or slave component.

Multiple system masters perform synchronized read and write transactions towards shared resources and process shared data structures, which are stored in these shared resources. System masters may be CPUs, a direct memory access (DMA) controller or a peripheral component interconnect express (PCIe) controller, etc. Shared resources may be a DDR SDRAM or an on-chip SRAM. Shared data structures may be DMA descriptors, Ethernet frames etc. The shared resources may also be peripherals, such as a pulse-code modulation (PCM) peripheral, a PCIe peripheral, and a universal serial bus (USB) peripheral, for example. This kind of synchronization is mandatory in order to prevent a malfunction of the entire embedded system.

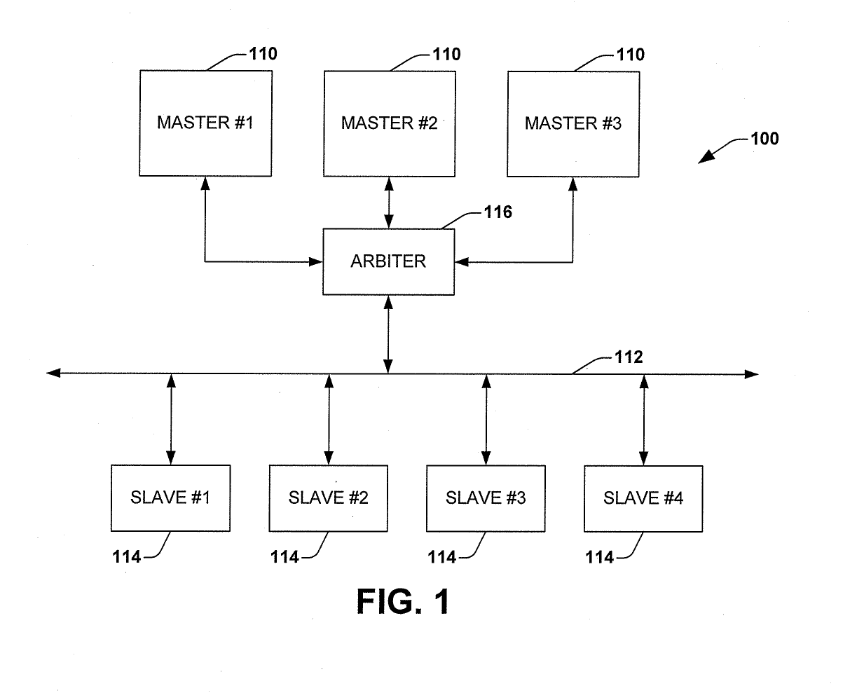

Typically the following synchronized and well defined sequence has to be observed in the traditional bus architecture of FIG. 1: (1) the “first” system master accesses the shared resources and processes the content of the shared data structure, (2) the “first” system master informs the “second” system masters that it has completed the operation, thereby granting the “second” system master access to the shared resources, and (3) the “second” system master then accesses the shared resources. Note: The read and write transaction towards the shared resources initiated by the “second” system master have to reach the shared resources after the read and write transaction towards these shared resources initiated by the “first” system master have completed. This can be achieved via arbitration, wherein the arbitration component grants the “first” master bus access, and then subsequently grants the “second” system master access to preclude conflict.

The synchronization effort gets complicated, when moving from simple multi-master-multi-slave bus based interconnects, e.g., advanced micro-controller bus architecture high performance bus (AMBA AHB) to high performing Crossbar or Network on Chip (NoC) based interconnects. A bus based interconnect prevents per default race conditions, because read and write transactions issued by multiple system masters use the same and only one data path (the AMBA AHB bus) towards the target. Furthermore, the arbitration logic associated with the bus based interconnect omits Quality of Service (QoS) features, that is, the AMBA AHB bus neither re-orders nor buffers transactions etc.

Race conditions in the context of this disclosure are defined as incorrect sequences of read and write transactions towards the shared data structures. This effect is caused by the interconnect due to new quality of service (QoS) features.

A crossbar based interconnect architecture (which may be more generalized as a switch fabric), or network on chip (NoC) based interconnect architecture, may implement the following new QoS features: (1) transaction re-order capabilities, (2) extensive transaction buffering (read and write transaction) as well as the associated write data, (3) different latencies in the request and response path between an initiator and a target, which may be caused by different operating frequencies, data path width, arbitration schemes in the request and response path, and (4) NoC based interconnects may implement multiple paths from an initiator (system master) to a target (system slave). As a consequence, a system master has no knowledge, when its transaction reaches the target. This is especially a challenge in the case of posted-write transactions. Posted write means that the initiator does not get an acknowledgement when the write operation is completed, that is, when the shared data structure is updated in the shared resource like DDR SDRAM.

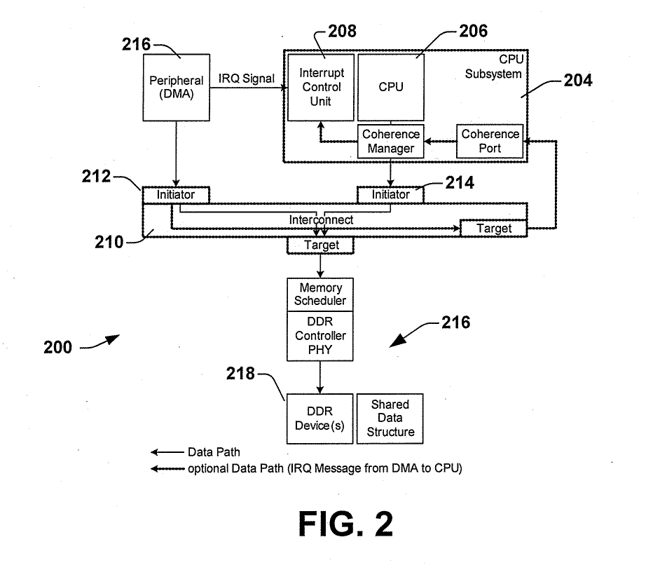

FIG. 2 illustrates in one system example 200 how problems can arise with transactions and events between two system masters, e.g., a DMA controller 202 and a CPU subsystem 204. In one example, the DMA controller 202 operates as the first system master, while the CPU subsystem 204 operates as the second system master. In one example, the CPU subsystem includes a CPU core 206 and an interrupt control unit 208, along with other support components. The DMA controller 202 and the CPU subsystem each interface with an interconnect 210 through respective initiator component interfaces 212 and 214. While a plurality of various slave components may couple to the interconnect 210 through respective target component interfaces, a single shared resource 216 is illustrated in FIG. 2 for purposes of simplicity. The shared resource 216 in this example is a DDR memory device 218 along with its associated support components.

The first system master updates shared data structures located in DDR SDRAM, e.g., a DMA writes an Ethernet frame to the DDR SDRAM. The DMA performs a posted-write; thus while the DMA knows that the write transaction was sent to the interconnect, the DMA does not receive an acknowledge. Furthermore, the DMA also does not know when the write transaction has completed within the target (e.g., that the entire Ethernet frame and the associated DMA descriptor was fully written to the memory). The DMA sends an interrupt request to the second system master, e.g., the CPU immediately after sending the write transaction. The CPU, upon being informed by the DMA, immediately initiates a transaction towards the shared data structure, for example, the CPU performs a read transaction to the shared data structure. In case the transaction initiated by the CPU reaches the shared resources earlier than the transaction initiated by the DMA, the embedded system may malfunction. Note: This effect may be caused by the interconnect due to re-ordering, write buffering techniques driven by the interconnect QoS features, for example.

The above described sequence that can result in a system malfunction may be improved, if the first system master performs a “blocking” read transaction to the shared data structure, immediately after completing updating the shared data structure. In such a solution, the DMA waits for the read response to be returned, before an interrupt request is sent to the second system master. This approach eliminates the race condition. It synchronizes the system masters and preserves the order of the transaction initiated by the first and second system master. The drawback is the additional “blocking” read transaction, i.e., wasting bandwidth of the shared resource. Especially the DDR SDRAM is a bottleneck within an embedded system.

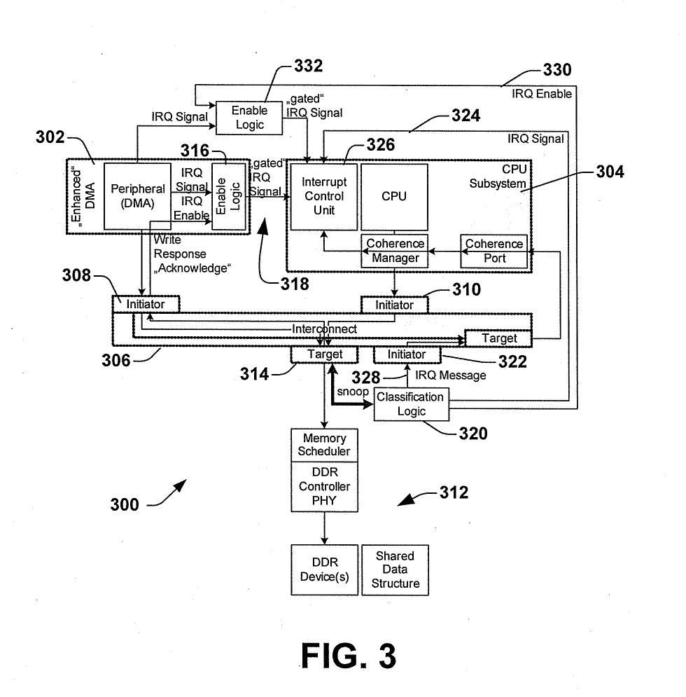

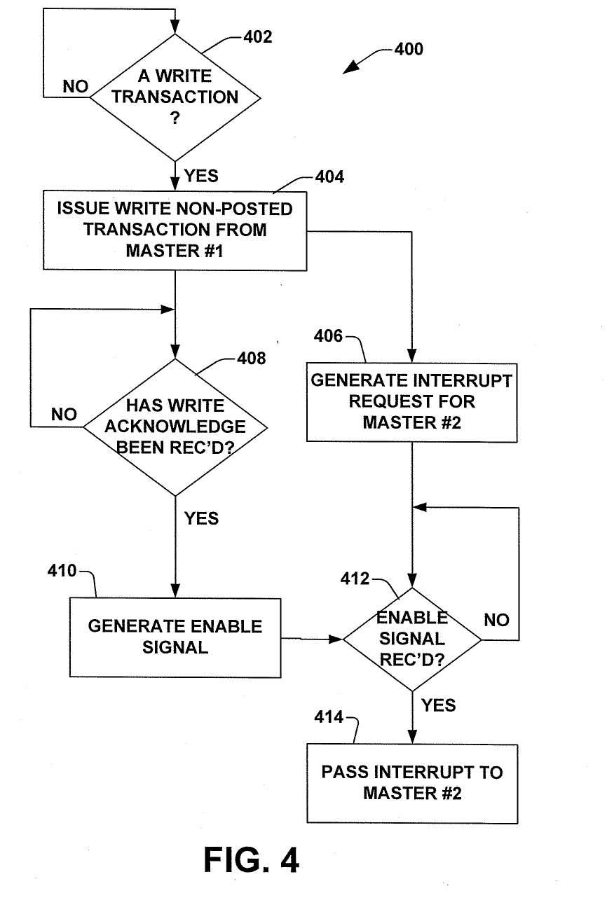

A solution according to one embodiment of the invention describes reliable and high performing systems and methods to synchronize read and write transactions as well as events (trigger, interrupt requests and messages) between multiple system masters. This is achieved by extending the functionality of the interconnects as described more fully below in conjunction with FIGS. 3 and 4.

FIG. 3 is a block diagram illustrating a multi-master interconnect architecture 300 having at least one shared resource. The architecture 300 includes a first master component 302 (e.g., a DMA controller) and a second master component 304 (e.g., a CPU subsystem) that couple to an interconnect 306 (e.g., a crossbar, switch fabric or NoC interconnect) via respective initiator interfaces 308 and 310. The architecture 300 also includes a shared resource 312 (e.g., a DDR memory), which also may be referred to as a slave component that is accessible to multiple masters. The shared resource 312 couples to the interconnect via a target interface 314. While FIG. 3 illustrates only two master components and only one shared resource, it should be appreciated that the disclosure contemplates a plurality of master components and a plurality of shared resources in various embodiments. In addition, while the shared resource 312 of FIG. 3 illustrates multiple elements associated with a DDR memory system, it should be understood that other types of shared resources are contemplated, and that even if the shared resource is a DDR memory system, various elements such as a DDR memory controller are optional, and the present disclosure should not be interpreted in any limiting fashion.

In one embodiment the first master component 302 further comprise enable logic 316 as well as other components that collectively operate to ensure proper synchronization for read and write transactions and events between multiple master components. While in some instances transactions and events may differ, for purposes of this disclosure, the term transaction is used broadly to include both transactions and events. The first master component further comprises an issuance component (not shown) that operates to issue any write transaction as a write non-posted transaction. Thus when the first master component 302 wishes to issue a write transaction to the shared resource 312, the issuance component operates to ensure that the write transaction is a write non-posted transaction. As may be appreciated, upon completion of the write non-posted transaction at the shared resource 312, a write acknowledgement 318 is issued and transmitted back to the first master component 302.

Still referring to FIG. 3, the first master component 302 includes an interrupt request generation component (not shown) that operates to generate an interrupt request once the write non-posted transaction has been issued. In one embodiment the interrupt request generation component generates the interrupt request immediately upon the write non-posted transaction being issued. The enable logic 316 includes an enable component that is configured to pass the generated interrupt request (received from the interrupt request generation component) to another master component as a gated interrupt request (IRQ) signal 318. In the above manner, since the interrupt request has already been generated, as soon as the write acknowledgement has been received the gated IRQ signal is immediately released for transmission to the second master component 304. In the above manner, a race condition between the first and second master components 302 and 304 is avoided.

In accordance with another embodiment of the disclosure, a method of performing synchronized read and write transactions in a multi-master interconnect architecture having at least one shared resource (e.g., such as that illustrated in FIG. 3) is provided, as illustrated in FIG. 4 at 400. The method 400 begins at 402 were a query is made whether a write transaction is necessary for a master component (e.g., such as component 302 in FIG. 3). If a determination is made that a write transaction is needed (YES at 402), a write non-posted transaction is issued from the master component at 404. In one embodiment such a transaction may be issued by an issuance component as described above. The method 400 proceeds to 406, wherein an interrupt request is generated by the master component for another master component (e.g., first master component 302 generating an IRQ signal for the second master component 304). Concurrently, the method 400 proceeds at 408, wherein the first master component awaits receipt of a write acknowledge from the shared resource indicating the write transaction is completed. Once the write acknowledge is received (YES at 408), the master component generates an enable signal at 410. At 412 the generated IRQ signal is held (NO at 412) until the generated enable signal at 410 is received (YES at 412), at which time the IRQ signal is released so it can be transmitted to the second master component (e.g., the gated IRQ signal to the second master component 304 as illustrated in FIG. 3).

Therefore a system master is modified in accordance with one embodiment of the invention in order to issue write non-posted transactions. Each time the write non-posted transaction including the associated write data has reached the target, a write acknowledge is returned to the “first” system master. The “first” system master delays the interrupt request to the “second” system master e.g. CPU, until it has received the write acknowledge. This delay of the interrupt request is achieved in one embodiment with new “enable logic” as well as the “first” system master issuing write non-posted transactions. Note: Typically, a write non-posted transaction is performed for the last DMA descriptor update.

In accordance with another embodiment of the disclosure, the master components are not limited to a write non-posted type of transaction. In this embodiment, a classification logic is employed at the shared resource (i.e., the slave component). The classification logic analyses or evaluates those transactions from various master components that pass the respective target interface, and then selectively generates events and/or transactions according to pre-defined classification rules based on the analyzed transaction.

The classification logic is associated with a target interface of a shared resource in order to analyze the transactions, while they are passing the target, to be completed within the system slave. The classification logic may generate events and/or transactions according to pre-defined classification rules. For example, the first system master 302 (e.g., the DMA controller) updates the DMA descriptor in the shared resource 312, after the payload has been written to DDR SDRAM. The classification logic detects this DMA descriptor update and generates an event and/or transaction.

Referring still to FIG. 3, classification logic 320 is shown at the target interface of the shared resource 312 (e.g., the DDR memory). As shown, the “snoop” label in the figure alludes to the classification logic 320 analyzing the transactions after they have exited the interconnect 306 and are passing through the target interface 314 as it moves to the shared resource 312. The classification logic 320 may also have its own initiator interface 322 for transmitting a generated event or transaction to the interconnect 306 itself or to one or more master components via the interconnect.

Still referring to FIG. 3, the classification logic 320 may generate, for example, the following events and/or transactions: (1) issue an interrupt request (IRQ signal) via a dedicated signal 324 to the interrupt control unit 326, or any other system master, (2) send an interrupt (IRQ) message 328 to the interrupt control unit (note: the interrupt message is then converted into a traditional interrupt request within the CPU Subsystem), (3) activate an interrupt request enable signal (IRQ enable) 330 to an enable logic 332, and/or (4) send a pre-defined message via the interconnect 306 to any system master.

The interconnect 306 classifies transactions and generates events and/or transactions in a pre-defined and expected order. A classification logic 320 is placed beside each target interface of a shared resource, analyzes the type of transaction (read, write non-posted, posted write, bust, single etc.), the initiator of the transaction (which system master), the content and the target address of the transaction, etc.

Locating the classification logic 320 at the target interface of each shared resource ensures that a transaction is classified after reaching the target interface 314, i.e., the “initial” transaction has successfully completed. The interconnect 306 therefore can no longer affect the transaction at issue, e.g., re-order, delay, error terminate, etc. Furthermore, the shared resource 312, for example, system slave connected to the target interface 314 takes care that transactions from multiple system masters towards the same address or address range are executed by the system slave in the order in which they have arrived at the target interface 314.

The classification logic 320 generates “derived” events and/or transactions, according to pre-defined classification rules while analyzing the “initial” transaction passing by. “Derived” events may be interrupt requests, start/stop conditions, enable/disable conditions, etc. “Derived” transactions may be acknowledge messages, interrupt messages, or any other type of message transferred via the interconnect 306. The destination of a “derived” event or transaction may be the system master who initiated the “initial” transaction, as well as any other logic block within the embedded system. A “derived” event or transaction reaches the destination time wise after the “initial” transaction has passed the target interface 314 and, in most cases, has completed in the system slave.

“Derived” events or transactions cause “synchronized” actions in a system master, optionally in any other logic block. For example, a system master like a CPU initiates a transaction towards a system slave, accessing shared data structures. The order of transactions towards shared resources and shared data structures is preserved, due to the above described synchronization scheme.

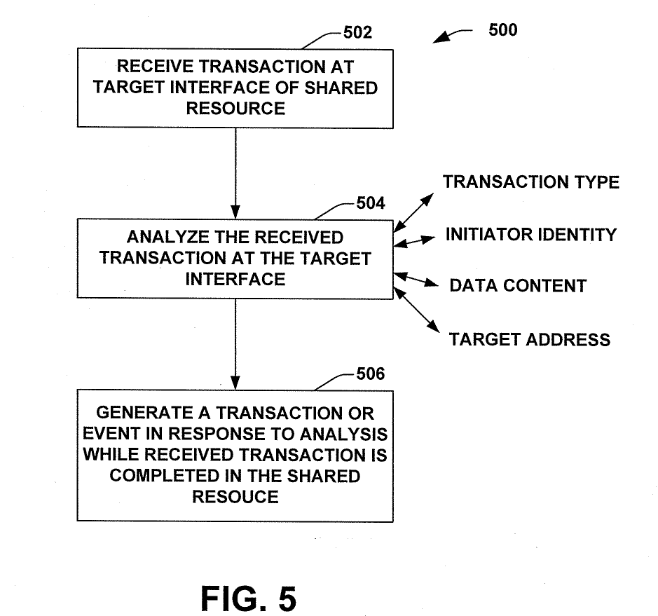

In yet another embodiment of the invention, a method of providing synchronization for transactions in a multi-master interconnect architecture having at least one shared resource is disclosed in FIG. 5 at 500. The method 500 comprises receiving a transaction at a target interface of the shared resource that is coupled to an interconnect. For example, as illustrated in FIG. 3, the target interface 314 may receive a write transaction from the first master 302 for the shared resource 312. The method 500 continues at 504 by analysing the received transaction at the target interface. For example, as illustrated in FIG. 3, the classification logic 320 may analyse the transaction at the target interface 314 to identify the type of transaction, identify who initiated the transaction, evaluate the data content of the transaction, and/or identify the target address of the transaction in the shared resource. The method 500 concludes at 506 by generating a transaction or event in response to the analysis at 504. Such generated transactions or events may include issuing an interrupt request via a dedicated signal for transmission to an interrupt control unit of a master component, generating and sending an interrupt message to an interrupt control unit of a master component through the interconnect, or activating an interrupt request enable signal for use in gating an interrupt request from one master component to another master component.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A method for performing synchronized transactions in a multi-master interconnect architecture having at least one shared resource, comprising:
issuing a write non-posted transaction from a first master component to the interconnect for access to the at least one shared resource;
generating at the first master component an interrupt request for a second master component upon issuance of the write non-posted transaction for indication thereof;
receiving a write acknowledgement upon completion of the issued write non-posted transaction;
generating an enable signal upon receiving the write acknowledgement; and
using the enable signal to pass the generated interrupt request to the second master component, thereby indicating completion of the write non-posted transaction of the first master component and thus avoiding a race condition.

2. The method of claim 1, wherein using the enable signal to pass the generated interrupt request to the second master component comprises:
inputting the interrupt request to a first input of a logic gate component; and
inputting the enable signal to a second input of the logic gate component,
wherein the logic gate component is configured to pass the interrupt request to an output thereof upon a change in state of the enable signal indicating receipt of the write acknowledgement.

3. The method of claim 1, wherein the receipt of the write acknowledgement occurs at the first master component.

4. The method of claim 3, wherein the enable signal is generated at the first master component.

5. The method of claim 1, wherein generating the enable signal comprises using the received write acknowledgement as the enable signal.

6. A master component configured to operate within a multi-master interconnect architecture that utilizes at least one shared resource, comprising:
an issuance component configured to issue a write non-posted transaction for writing data to the at least one shared resource;
an interrupt request generation component configured to generate an interrupt request upon issuance of the write non-posted transaction; and
an enable component configured to pass the generated interrupt request to another master component of the multi-master interconnect architecture upon receipt of a write acknowledgement indicating a completion of the write non-posted transaction.

7. The master component of claim 6, wherein the enable component comprises a logic gate comprising a first input configured to receive the interrupt request, a second input configured to receive an enable signal associated with a status of receipt of the write acknowledgement, and an output configured to output the interrupt request upon a state of the enable signal indicating receipt of the write acknowledgement.

8. The master component of claim 7, wherein the interrupt request is generated by the interrupt request generation component immediately upon issuance of the write non-posted transaction, such that the interrupt request waits at the enable component, such that upon the state of the enable signal indicating receipt of the write acknowledgement, the interrupt request is immediately output for transmission to another master component.

9. The master component of claim 6, wherein every form of write transaction to be performed by the master component is converted to a write non-posted transaction before being issued by the issuance component.

10. A shared resource system configured to operate within a multi-master interconnect architecture, comprising:
a target interface configured to couple to an interconnect for receipt of transactions from a master component via the interconnect;
a shared resource component operably coupled to the target interface and configured to receive data or an instruction via the target interface associated with a received transaction; and
a classification logic component operably associated with the target interface and configured to analyze a received transaction passing through the target interface and generate a transaction or an event in response thereto according to pre-defined classification rules.

11. The shared resource system of claim 10, wherein the transaction or event generated by the classification logic component comprises issuance of an interrupt request via a dedicated signal for transmission to an interrupt control unit of a master component.

12. The shared resource system of claim 10, wherein the transaction or event generated by the classification logic component comprises generating and send an interrupt message to an interrupt control unit of a master component through the interconnect.

13. The shared resource system of claim 10, wherein the transaction or event generated by the classification logic component comprises activating an interrupt request enable signal for use in gating an interrupt request from one master component to another master component.

14. The shared resource system of claim 10, wherein the classification logic component is configured to analyze transaction to establish whether the transaction is a read, a write, a non-posted write, a posted write, or a burst.

15. The shared resource system of claim 10, wherein the classification logic component is configured to analyze the transaction to determine an identity of the initiator of the transaction.

16. The shared resource system of claim 10, wherein the classification logic component is configured to analyze the transaction to identify a content thereof.

17. The shared resource system of claim 10, wherein the classification logic component is configured to analyze the transaction to identify a target address of the transaction within the shared resource component.

18. A method of providing synchronization for transactions in a multi-master interconnect architecture having a shared resource, comprising:
receiving a transaction at a target interface of the shared resource, wherein the target interface is configured to couple to an interconnect;
analyzing the received transaction at the target interface; and
generating a transaction or event in response to analyzing the received transaction, wherein the generated transaction or event is local to the shared resource.

19. The method of claim 18, further comprising transmitting the generated transaction or event to a master component of the multi-master interconnect architecture, wherein transmitting is performed through the interconnect to the master component or directly to the master component.

20. The method of claim 18, wherein analyzing the received transaction comprises one or more of: determining a type of the received transaction, determining an identity of the initiator of the received transaction, evaluating a data content of the received transaction, and identifying a target address of the received transaction in the shared resource.
